(19) United States
(12) Patent Application Publication
(10) Pub. No.: US 2021/0222020 A1
(43) Pub. Date: Jul. 22, 2021

(54) PEROVSKITE INK AND METHOD FOR MANUFACTURING SAME

(71) Applicant: Shenzhen China Star Optoelectronics Semiconductor Display Technology Co., Ltd., Shenzhen, Guangdong (CN)

(72) Inventor: Yunan ZHANG, Shenzhen, Guangdong (CN)

(21) Appl. No.: 16/301,852

(22) PCT Filed: Sep. 26, 2018
(86) PCT No.: PCT/CN2018/107494

§ 371 Date: Nov. 15, 2018

(30) Foreign Application Priority Data
Sep. 6, 2018 (CN) 201811038361.X

(51) Int. Cl. C09D 11/38; C09D 11/36; C09D 11/328; C09D 11/50; C09D 11/033; C09D 11/322; C09D 11/52; C09K 11/06

(52) U.S. Cl. CPC C09D 11/38; C09D 11/36; C09D 11/328; C09D 11/50; C09K 2211/10; C09D 11/322; C09D 11/52; C09K 11/06; C09D 11/033

(57) ABSTRACT

The present disclosure provides a perovskite ink used for ink-jet printing. The perovskite ink includes a solvent, a perovskite material dispersed in the solvent, a surface tension modifier, and a viscosity modifier. The perovskite ink further includes a polymer doping material that is configured to increase a film formation ability of the perovskite material.

### FIELD OF INVENTION

The present disclosure relates to the field of liquid crystal display panels, and more particularly to a perovskite ink and a method for manufacturing same.

### BACKGROUND

Organic-inorganic hybrid perovskite material is a semiconductor material that can be easily processed, and has low cost, high carrier mobility, and large optical absorption coefficient properties, therefore organic-inorganic hybrid perovskite material, in recent years, is widely used in field of solar cells. In addition, having adjustable wavelength and narrow emission spectrum properties, perovskite material can also be used in field of electroluminescence, lasers, and displays. Organic-inorganic hybrid perovskite material, possessing both organic and inorganic semiconductor material properties, can be easily processed for film formation process on large areas. Moreover, organic-inorganic hybrid perovskite material, like conventional inorganic luminescent material, has low defect density, high luminescent efficiency, and excellent color purity characteristics.

Perovskite material is able to be dispersed in solvent, thus producing ink. Thus, perovskite material could be used to form perovskite luminescent film using techniques, such as ink-jet printing, pad printing, or spin coating. In which, ink-jet printing technique precisely deposits desired amount of quantum dot material at predetermined location, and forms sophisticated pixel film, therefore ink jet printing technique is helpful in reducing production cost for manufacturing large-sized colorful perovskite light-emitting diode (PeLED).

However, for being used for ink-jet printing technique, ink has to satisfy some specific requirements. For example, to have ink be suitably used for ink-jet printing, it is required to further adjust constituents, viscosity, and surface tension of ink. Therefore, there is a need to provide a perovskite ink that is suitably used for ink-jet printer and ink-jet printing technique.

### SUMMARY OF DISCLOSURE

The present disclosure provides a perovskite ink for in jet printing to solve the problems existing in the prior art, where the perovskite ink for in-jet printing is not suitably used for ink-jet printing.

The present disclosure provides a perovskite ink used for ink-jet printing. The perovskite ink includes a solvent, a perovskite material dispersed in the solvent, a surface tension modifier, and a viscosity modifier. The perovskite ink further includes a polymer doping material that is configured to increase a film formation ability of the perovskite material. The perovskite material has a mass percentage of 0.1-30% in the ink, the solvent has a mass percentage of 10-99.99% in the ink, the viscosity modifier has a mass percentage of 0.1-5% in the ink, and the polymer doping material has a mass percentage of 10-90% in the ink. The perovskite material has a chemical formula of CH₃NH₃PbX₃, wherein X is Cl, Br, or I.

Preferably, the polymer doping material is a polyimide polymer or a polyethylene oxide polymer.

Preferably, the solvent includes at least one alkane or aromatic compound, at least one alcohol compound, and at least one auxiliary Solvent having a boiling point higher than 200° C.

In addition, the present disclosure provides a perovskite ink used for ink-jet printing. The perovskite ink includes a solvent, a perovskite material dispersed in the solvent, a surface tension modifier, and a viscosity modifier. The perovskite ink further includes a polymer doping material that is configured to increase a film formation ability of the perovskite material.

Preferably, the perovskite material has a mass percentage of 0.1-30% in the ink, the solvent has a mass percentage of 10-99.99% in the ink, the viscosity modifier has a mass percentage of 0.1-5% in the ink, and the polymer doping material has a mass percentage of 10-90% in the ink.

Preferably, the polymer doping material is a polyimide polymer or a polyethylene oxide polymer.

Preferably, the perovskite material has a chemical formula of CH₃NH₃PbX₃, wherein X is Cl, Br, or I.

Preferably, the solvent includes at least one alkane or aromatic compound, at least one alcohol compound, and at least one auxiliary solvent having a boiling point higher than 200° C.

Moreover, the present disclosure provides a method for manufacturing a perovskite ink used for ink-jet printing, comprising:

a step S10 of dispersing a perovskite material and a polymer doping material in a solvent, so as to obtain a perovskite solution; and

a step S20 of stirring the perovskite solution, adding a viscosity modifier and a surface tension modifier into the perovskite solution, and well mixing the viscosity modifier and the surface tension modifier with the perovskite solution, such that the perovskite ink is produced.

Preferably, the perovskite material has a mass percentage of 0.1-30% in the ink, the solvent has a mass percentage of 10-99.99% in the ink, the viscosity modifier has a mass percentage of 0.1-5% in the ink, and the polymer doping material has a mass percentage of 10-90% in the ink.

Preferably, the polymer doping material is a polyimide polymer or a polyethylene oxide polymer.

Preferably, the perovskite material has a chemical formula of CH₃NH₃PbX₃, wherein X is Cl, Br, or I.

Preferably, the solvent includes at least one alkane or aromatic compound, at least one alcohol compound, and at least one auxiliary solvent having a boiling point higher than 200° C.

According to the present disclosure, the surface tension modifier and the, viscosity modifier respectively adjust surface tension and viscosity of the ink, therefore the ink could be suitably used for ink-jet printing. In addition, the polymer doping material increases film formation ability of the perovskite ink without influencing device performance, therefore occurrence of pinholes is avoided during film formation process, thus improving luminescent functional effect of PeLED device.

### BRIEF DESCRIPTION OF DRAWINGS

To explain in detail the technical schemes of the embodiments or existing techniques, drawings that are used to illustrate the embodiments or existing techniques are provided. The illustrated embodiments are just a part of those of the present disclosure. It is easy for any person having ordinary skill in the art to obtain other drawings without labor for inventiveness.

FIG. 1 is a schematic diagram showing a flowchart of a method for manufacturing a perovskite ink used for ink-jet printing according to one embodiment of the present disclosure.

### DETAILED DESCRIPTION

The following embodiments refer to the accompanying drawings for exemplifying specific implementable embodiments of the present disclosure. Moreover, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto. In the drawings, the same reference symbol represents the same or similar components.

The present disclosure solves the problems existing in conventional perovskite ink where perovskite ink is not suitably used for ink-jet printing, and constituents, viscosity, and surface tension of ink have to be further adjusted.

The present disclosure provides a perovskite ink used for ink-jet printing. The perovskite ink includes a solvent, a perovskite material dispersed in the solvent, a surface tension modifier, and a viscosity modifier. The perovskite ink further includes a polymer doping material that is configured to increase a film formation ability of the perovskite material.

The surface tension modifier and the viscosity modifier respectively adjust surface tension and viscosity of the ink, therefore the ink could be suitably used for ink-jet printing. In addition, the polymer doping material increases film formation ability of the perovskite ink without influencing device performance, therefore occurrence of pinholes is avoided during film formation process, thus improving luminescent functional effect of PeLED device.

Specifically, the perovskite material has a mass percentage of 0.1-30% in the ink, the solvent has a mass percentage of 10-99.99% in the ink, the viscosity modifier has a mass percentage of 0.1-5% in the ink, and the polymer doping material has a mass percentage of 10-90% in the ink.

Specifically, the solvent includes at least one alkane or aromatic compound, at least one alcohol compound, and at least one auxiliary solvent having a boiling point higher than 200° C. The solvent has a boiling point higher than 200° C. This helps in increasing boiling point of the produced perovskite ink, ensuring that the ink would not be dried too fast during ink-jet printing process, and increasing stability of ink-jet printing process.

The alcohol compound is a monohydric alcohol or a polyhydric alcohol.

The auxiliary solvent is an ether or ester compound.

Specifically, the perovskite material has a chemical formula of CH₃NH₃PbX₃, wherein X is Cl, Br, or I. By selecting a halide anion X in the perovskite material, adjustment of different light colors can be achieved.

Specifically, the surface tension modifier is selected from one of an imidazole and a derivative thereof, a phenol, a hydroquinone, or a combination thereof.

Specifically, the viscosity modifier is selected from one of an alcohol, an ether, an ester, a phenol, an amine, and a combination thereof.

Specifically, the polymer doping material is a polyimide polymer (PIP) or a polyethylene oxide (PEO) polymer. By mixing the polymer doping material into the perovskite material, film formation ability of the perovskite material can be increased without influencing device performance. Therefore, occurrence of pinholes is avoided during film formation process, improving luminescent functional effect of PeLED device.

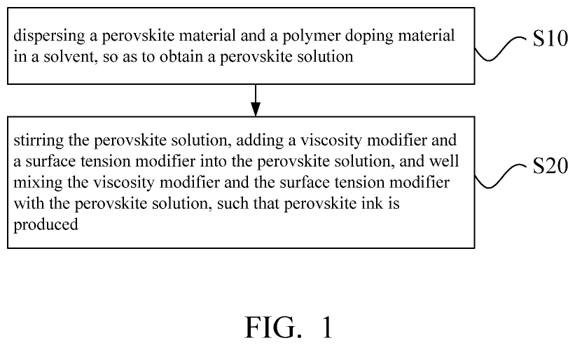

The present disclosure further provides a method for manufacturing a perovskite ink used for ink-jet printing. As shown in FIG. 1, the method for manufacturing a perovskite ink used for ink-jet printing includes:

a step S10 of dispersing a perovskite material and a polymer doping material in a solvent, so as to obtain a perovskite solution; and

a step S20 of stirring the perovskite solution, adding a viscosity modifier and a surface tension modifier into the perovskite solution, and well mixing the viscosity modifier and the surface tension modifier with the perovskite solution, such that thperovskite ink is produced.

Specifically, the perovskite material has a mass percentage of 0.1-30% in the ink, the solvent has a mass percentage of 10-99.99% in the ink, the viscosity modifier has a mass percentage of 0.1-5% in the ink, and the polymer doping material has a mass percentage of 10-90% in the ink.

Specifically, the solvent includes at least one alkane or aromatic compound, at least one alcohol compound, and at least one auxiliary solvent having a boiling point higher than 200° C.

The alcohol compound is a monohydric alcohol or a polyhydric alcohol.

The auxiliary solvent is an ether or ester compound.

Specifically, the perovskite material has a chemical formula of CH₃NH₃PbX₃, wherein X is Cl, Br, or I. By selecting a halide anion X in the perovskite material, adjustment of different light colors can be achieved.

Specifically, the surface tension modifier is selected from one of an imidazole and a derivative thereof, a phenol, a hydroquinone, or a combination thereof.

Specifically, the viscosity modifier is selected from one of an alcohol, an ether, an ester, a phenol, an amine, and a combination thereof.

Specifically, the polymer doping material is a polyimide polymer (PIP) or a polyethylene oxide (PEO) polymer.

According to the present disclosure, the surface tension modifier and the viscosity modifier respectively adjust surface tension and viscosity of the ink, therefore the ink could be suitably used for ink-jet printing. In addition, the polymer doping material increases film formation ability of the perovskite ink without influencing device performance, therefore occurrence of pinholes is avoided during film formation process, thus improving luminescent functional effect of PeLED device.

While the present disclosure has been described with the aforementioned preferred embodiments, it is preferable that the above embodiments should not be construed as limiting of the present disclosure. Anyone having ordinary skill in the art can make a variety of modifications and variations without departing from the spirit and scope of the present disclosure as defined by the following claims.

What is claimed is:

1. A perovskite ink used for ink-jet printing, comprising:
a solvent;
a perovskite material dispersed in the solvent;
a surface tension modifier; and
a viscosity modifier;
wherein the perovskite ink further includes a polymer doping material that is configured to increase a film formation ability of the perovskite material; wherein the perovskite material has a mass percentage of 0.1-30% in the ink, the solvent has a mass percentage of 10-99.99% in the ink, the viscosity modifier has a mass percentage of 0.1-5% in the ink, the polymer doping material has a mass percentage of 10-90% in the ink; and wherein the perovskite material has a chemical formula of CH₃NH₃PbX₃, wherein X is Cl, Br, or I.

2. The perovskite ink used for ink-jet printing according to claim 1, wherein the polymer doping material is a polyimide polymer or a polyethylene oxide polymer.

3. The perovskite ink used for ink-jet printing according to claim 1, wherein the solvent includes at least one alkane or aromatic compound, at least one alcohol compound, and at least one auxiliary solvent having a boiling point higher than 200° C.

4. A perovskite ink used for ink-jet printing, comprising:
a solvent;
a perovskite material dispersed in the solvent;
a surface tension modifier; and
a viscosity modifier;
wherein the perovskite ink further includes a polymer doping material that is configured to increase a film formation ability of the perovskite material.

5. The perovskite ink used for ink-jet printing according to claim 4, wherein the perovskite material has a mass percentage of 0.1-30% in the ink, the solvent has a mass percentage of 10-99.99% in the ink, the viscosity modifier has a mass percentage of 0.1-5% in the ink, the polymer doping material has a mass percentage of 10-90% in the ink.

6. The perovskite ink used for ink-jet printing according to claim 4, wherein the polymer doping material is a polyimide polymer or a polyethylene oxide polymer.

7. The perovskite ink used for ink-jet printing according to claim 4, wherein the perovskite material has a chemical formula of CH₃NH₃PbX₃, wherein X is Cl, Br, or I.

8. The perovskite ink used for ink-jet printing according to claim 4, wherein the solvent includes at least one alkane or aromatic compound, at least one alcohol compound, and at least one auxiliary solvent having a boiling point higher than 200° C.

9. A method for manufacturing a perovskite ink used for ink-jet printing, comprising:
a step S10 of dispersing a perovskite material and a polymer doping material in a solvent, so as to obtain a perovskite solution; and
a step S20 of stirring the perovskite solution, adding a viscosity modifier and a surface tension modifier into the perovskite solution, and well mixing the viscosity modifier and the surface tension modifier with the perovskite solution, such that the perovskite ink is produced.

10. The method for manufacturing the perovskite ink used for ink-jet printing according to claim 9, wherein the perovskite material has a mass percentage of 0.1-30% in the ink, the solvent has a mass percentage of 10-99.99% in the ink, the viscosity modifier has a mass percentage of 0.1-5% in the ink, the polymer doping material has a mass percentage of 10-90% in the ink.

11. The method for manufacturing the perovskite ink used for ink-jet printing according to claim 9, wherein the polymer doping material is a polyimide polymer or a polyethylene oxide polymer.

12. The method for manufacturing the perovskite ink used for ink-jet printing according to claim 9, wherein the perovskite material has a chemical formula of CH₃NH₃PbX₃, wherein X is Cl, Br, or I.

13. The method for manufacturing the perovskite ink used for ink-jet printing according to claim 9, wherein the solvent includes at least one alkane or aromatic compound, at least one alcohol compound, and at least one auxiliary solvent having a boiling point higher than 200° C.
